(19) United States
(12) Patent Application Publication
(10) Pub. No.: US 2025/0291754 A1
(43) Pub. Date: Sep. 18, 2025

(54) Adaptive Burst Transfer for Direct Memory Access

(71) Applicant: Texas Instruments Incorporated, Dallas, TX (US)

(72) Inventors: Varshashree Kottadamane Manjunatha Swamy, Bangalore (IN); Prasanth Viswanathan Pillai, Bangalore (IN); Saya Goud Langadi, Sugar Land, TX (US); Devi Anilkumar, Reutlingen (DE)

(73) Assignee: Texas Instruments Incorporated, (omitted)

(21) Appl. No.: 18/790,877

(22) Filed: Jul. 31, 2024

Related U.S. Application Data
(60) Provisional application No. 63/563,994, filed on Mar. 12, 2024.

(51) Int. Cl. G06F 13/28

(52) U.S. Cl. CPC G06F 13/28; G06F 2213/28

(57) ABSTRACT

A system and method allow for adaptable direct memory Access (DMA) burst transactions. The DMA controller may be configured to define a beginning and an end of a burst transaction using signals that do not necessarily correspond to an end of a data chunk being transferred. The DMA controller may be configured to end a burst transaction before the data chunk has been read or may extend a burst transaction to accommodate a contiguous range of addresses. The DMA controller may also be configured to terminate a lower-priority burst transaction to accommodate a higher-priority burst transaction and then re-start the lower-priority burst transaction.

### CROSS-REFERENCE TO RELATED APPLICATIONS

This application claims the benefit of U.S. Provisional Patent Application 63/563,994 filed Mar. 12, 2024, the disclosure of which is hereby incorporated by reference in its entirety.

### TECHNICAL FIELD

The present description relates generally to direct memory access (DMA) and, more specifically, to systems and methods to provide an adaptive burst transfer for DMA.

### BACKGROUND

Direct memory access (DMA) is a feature within modern computer systems that facilitates data transfer among and between the main memory and peripheral devices. Examples of peripheral devices include hard drives, analog-to-digital converters, and the like. In one example, a host (e.g., a processor core) writes a DMA command block into memory. The DMA command block may include a pointer to a source of the transfer, a pointer to the destination of the transfer, and a size of a quantity of bytes to be transferred. The host may transmit the DMA command block to a DMA controller as a trigger.

Once triggered, the DMA controller may read the data from the source and write the data to the destination. When the transfer is complete, the DMA controller may send an interrupt signal to the CPU.

In some examples, a DMA controller may transfer a single word from a source to a destination. In other examples, DMA controller may perform a sequential read of a multitude of addresses at the source to transfer a multitude of words in a single transfer. However, in many current systems, the sequential read from the source is performed in such a way that it may not be terminated before the end of the transfer. Therefore, in situations in which the data might be corrupted, or there may be some other error, the sequential read from the source may be performed until completion, thereby wasting the resources of the DMA controller and of the data source.

### SUMMARY

In one embodiment, a direct memory access (DMA) controller is configured to: receive an identifier of data to be transferred from a source device to a destination device; begin a read operation of the data by providing a set of signals that specifies to the source device an expected size of the data and that specifies to begin reading at least a portion of the data; determine to terminate the read operation before the expected size of the data has been met; and terminate the read operation.

In one embodiment, a method includes: receiving a read command from a direct memory access (DMA) controller, wherein the read command indicates a sequential read operation having an address of data and indicates an expected size of a set of data associated with the read command; providing exclusive bus access to the DMA controller for the sequential read operation; in response to the read command, reading data from an address range associated with the address of data; and terminating reading the data prior to reading an entirety of the set of data in response to a signal from the DMA controller indicating releasing the exclusive bus access.

In yet another embodiment, a system includes: a processor core; a direct memory access (DMA) controller configured to communicate with the processor core; and a plurality of devices configured to communicate with the DMA controller; wherein the DMA controller is configured to: receive a trigger indicating a burst data transfer of a set of data from a first device of the plurality of devices to a second device of the plurality of devices; read a subset of the set of data for the burst data transfer from the first device, including transmitting a first signal to the first device to cause the first device to provide exclusive bus access to the DMA controller; and transmit a second signal to the first device to cause the first device to release the exclusive bus access at a time that is prior to reading of an end of the set of data.

### BRIEF DESCRIPTION OF THE DRAWINGS

Having thus described the invention in general terms, reference will now be made to the accompanying drawings, wherein:

FIG. 1 is an illustration of an example system, which may provide burst operation in a DMA transfer, according to various embodiments.

FIG. 2 is an illustration of an example adaptive burst transfer, which may be performed by a DMA controller during a burst transfer from a source target port to a destination target port, according to various embodiments.

FIG. 3 is an illustration of example adaptive data transfers, which may be performed by a DMA controller, according to various embodiments.

FIGS. 4A and 4B are an illustration of an example burst data transfer, which may be performed by the system of FIG. 1, according to various embodiments.

FIG. 5 is an illustration of operation of a DMA controller to extend a read operation, according to various embodiments.

FIG. 6 is an illustration of an example method, to provide adaptive burst transfer control, according to various embodiments.

FIG. 7 is an illustration of an example method, for accommodating adaptable burst transactions, according to various embodiments.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Various embodiments are directed to an adaptive burst transfer scheme for direct memory access (DMA). For instance, various embodiments may allow for terminating a burst transfer at a time other than a time that corresponds to an end of a data chunk.

Some computing applications use transfers of large amounts of data from a source to a destination. In general, the total number of cycles for transferring N beats of data is based on the number of beats (N) times the number of cycles per beat transfer. Data larger than a beat may be transferred using discrete beats, often with a delay between beats to terminate one beat and initiate the next, or grouped into bursts of beats, often with no delay between beats but with a delay between bursts. Burst mode may reduce the overall latency of the transfer of relatively large chunks of data by doing lookahead address generation. For instance, lookahead address generation may include a data source performing internal actions to read out the requested data, including initiating a read from a subsequent address in anticipation of receiving a read request for that subsequent address.

An example DMA burst mode transfers a fixed number of bytes from a data source to the DMA controller. The number of bytes (a burst length) may be provided by the DMA controller at the beginning of the burst using a signal, such as BYTECNT. Burst transactions may be non-interruptible even in the case of errors in the transfer. As a result, this type of burst transaction may waste cycles and provide corrupt data in the event of a safety or security error. This type of burst transaction may also stall a higher-priority channel until a previous lower-priority burst transaction is complete.

By contrast, examples of this disclosure remove the fixed burst length limitation by making the burst length definition optional. Instead, an example DMA controller provides a first signal (FIRST) to a target port (a data source) to indicate the start of a burst transfer and a second signal (LAST) to indicate the current address represents that last beat in the burst. In this way, the burst may be cancelled if unexpected conditions occur. In other words, various embodiments allow for a variable quantity of beats in a burst, based on a condition, such as a safety or security error, an incoming higher-priority transaction, or the like.

For compatibility, the DMA controller may still provide an expected number of bytes remaining (BYTECNT) to the data source. The DMA controller may also provide other signals to the data source such as a count (XCNT) of bytes to be transferred in a current beat.

This ability to interrupt burst transfers may benefit in the following situations. Terminating subsequent transfers due to any safety or security errors may avoid data corruption and cycle wastage. Also, the ability to release the arbitration of a lower priority channel for benefit of a higher priority channel (in case of multi-channel DMA) may allow the higher-priority channel to be addressed with less latency, and the DMA controller may return to complete the interrupted transfer for the lower priority channel.

Thus, some examples of the present disclosure provide a mechanism to terminate a burst early when any of the transactions/beats within the ongoing burst is blocked due to a security restriction or a security violation or when an error is generated. In contrast, if the burst access continues until all beats are complete, the available bandwidth may be wasted since the subsequent beats in the burst may also be blocked. To avoid this, the DMA controller may detect the security restriction and/or error and assert the LAST signal which indicates to the target port to terminate the ongoing burst. The target port may react to the LAST signal from the DMA controller by terminating the burst at the target side.

Similarly, in case of any safety errors detected during the transfer, the DMA controller may terminate the burst to ensure there is no further data corruption. The DMA controller's burst logic controller detects the safety error and asserts the LAST signal, which terminates the ongoing burst.

In some examples, the DMA controller may terminate a burst in favor of a higher-priority transfer. During an ongoing burst transfer, if a new higher-priority transfer request is received, terminating the ongoing burst and switching to the higher priority channel may ensure the higher priority requests are serviced with minimal latency. When a higher-priority request is received, the burst controller logic may de-assert a REQUEST signal to indicate to the target peripheral that ongoing burst has been terminated. The DMA controller may now switch to the higher-priority channel and service that request. Once the higher-priority request is complete, the DMA controller may switch to the terminated channel and perform the transfer of remaining beats of the lower-priority request as a new burst transfer.

In case of back-to-back burst transfers to linear locations from the same channel, there may be a latency penalty of at least one cycle to complete one burst and initiate the next. The latency penalty could be much higher if the target port is a shared resource and the target port released the arbitration to a different initiator upon seeing a LAST signal from the current initiator. If the internal FIFO has space to store data from the next ‘N’ transfers (N-no of beats in the burst), the ongoing burst may be extended by the DMA controller suppressing the LAST signal and the subsequent FIRST signal even if this causes the combined burst to exceed the initially predicted BYTECNT value for the first burst. With this, the target port continues to remain in burst transfer mode and does not release the arbitration lock. The DMA controller looks at the available space (for reads)/data (for writes) in the FIFO before issuing the last beat of ongoing burst to decide whether to continue to next burst or terminate (if the available space/data is <N) the burst with the LAST signal. By not forcing the DMA controller to comply with the BYTECNT value provides the DMA controller extra cycles to identify bursts to combine and to combine bursts even when the latter burst(s) were not contemplated when the first burst was initiated.

Target ports (e.g., a memory controller, a peripheral bridge, etc.) may lock the arbitration to the initiator that started the burst once FIRST is seen and remain in the arbitration lock until LAST=1 or REQUEST=‘0’ is seen. Target ports may also support adaptive burst by ignoring the BYTECNT information from initiator and depend on LAST/REQUEST signal for burst completion.

While no advantage is required for any particular embodiment, in some examples, the present solutions allow for terminating subsequent transfers due to any safety and/or security errors to avoid data corruption and/or cycle wastage. Some examples provide the DMA controller the ability to release the arbitration to a higher-priority channel (in case of multi-channel DMA). Furthermore, some examples provide the DMA controller the ability to extend the ongoing burst in case of back-to-back burst transfers, which may further reduce the latency of the transfer.

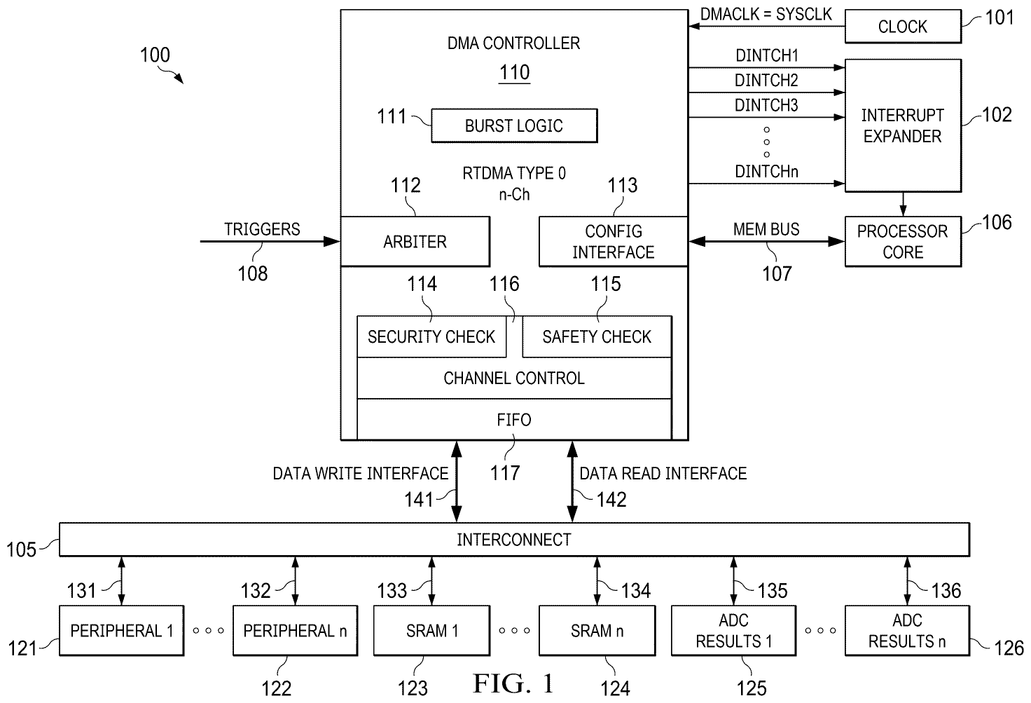

FIG. 1 is an illustration of an example system 100, which may provide burst operation in a DMA transfer, according to various embodiments. System 100 may be implemented as a system on-chip, where each of the different components shown in FIG. 1 are implemented on a semiconductor die. In another example, system memory may be implemented as SRAM devices 123, 124 and may be disposed on a different semiconductor die, which is configured to communicate with the semiconductor die having processor core 106. In some examples, a system on-chip and a memory chip may be included in a same semiconductor package. However, the scope of implementations is not limited to any specific arrangement of semiconductor dies.

System 100 includes processor core 106, and it is understood that the scope of implementations may include multiple processor cores. However, for ease of illustration, FIG. 1 shows only a single processor core-processor core 106. Processor core 106 may communicate with DMA controller 110. For instance, processor core 106 may communicate with DMA controller 110 via memory bus 107 and configuration interface 113 to configure parameters for DMA transfers. For instance, processor core 106 may set parameters to indicate a priority level of various channels. For instance, DMA controller 110 may support multiple (n) channels, and those channels may have different relative priorities, where one channel may have a higher or lower priority than another channel.

Furthermore, processor core 106 may communicate with DMA controller 110 by writing a DMA command block to DMA controller 110 or to any appropriate trigger source, where a trigger source may include any of target ports 121-126 or another device. Furthermore, processor core 106 may configure the DMA controller 110 by writing commands to the configuration interface 113. This may include some or all the information necessary to perform a DMA transfer (e.g., source address, destination address, size of transfer, trigger source, etc.). The triggers 108 for the DMA transfer may be transmitted by any of target ports 121-126 or another device configured to instruct the DMA controller 110 to start the DMA transfer. The DMA controller 110 may receive triggers 108 at arbiter module 112, which may apply channel priorities in the case of conflicts among channels. For instance, arbiter module 112 may allow a higher-priority channel to have its transfer performed before a transfer for a lower-priority channel.

DMA controller 110 is configured to communicate with target ports 121-126 via an interconnect 105. For instance, interconnect 105 may be a switch fabric or other tool to direct communications from DMA controller 110 to a particular one of the target ports 121-126. Each of the target ports 121-126 is communicatively coupled to the interconnect 105 by a respective bus 131-136. Each one of the target ports 121-126 represents a device, such as a peripheral device, a memory device, or a device storing ADC results. The scope of implementation is not limited to any particular type or number of devices that may include target ports.

The DMA controller 110 is communicatively coupled to the interconnect 105 by data write interface 141 and data read interface 142. A data transfer may include the DMA controller 110 reading data from a first one of the target ports 121-126 and writing the data to a different one of the target ports 121-126. For instance, the DMA controller 110 may read data from e.g., target port 121 and write that data to another one of the target ports e.g., 123. A write operation may take longer to complete than a read operation, so DMA controller 110 may include a first in first out (FIFO) buffer 117 to store the read-out data until that data can be written to the other target port.

Once the data for a transfer has been successfully written to a target port, the DMA controller 110 may then transmit an interrupt signal to the processor core 106 via the interrupt expander 102. For instance, the DMA controller 110 may use an interrupt line (one of DINTCH1 . . . n) which corresponds to a channel of the transfer just completed. In this example, the DMA controller 110 is controlled by a system clock 101, which also provides clock signals to the processor core 106.

In example system 100, processor core 106 may configure the DMA controller 110 for any data transfer by writing an instruction to configuration interface 113 in DMA controller 110. Similarly, any one or all of the target ports 121-126 may be configured to generate a trigger 108. For instance, target ports 125, 126 include results for analog-to-digital converters (ADCs), and those results (e.g., data words) are to be written to one of the memory devices of target ports 123 or 124. In one example, ADC 125 may be configured to generate a trigger 108 to cause DMA controller 110 to facilitate a transfer of data words from ADC target port 125 to SRAM target port 123. The same is true of the other ADC target port 126 and the peripheral target ports 121, 122.

DMA controller 110 may be configured to perform burst transfers of data from one of the target ports 121-126 to another one of the target ports 121-126. DMA controller 110 includes burst logic 111, which may be hardware logic or may be implemented using firmware or software functionality. Burst logic 111 may include functionality to facilitate a burst transfer, and burst logic 111 may further include functionality to terminate the burst transfer at a time other than an end of the burst, as described in more detail below.

In one example, a burst transfer may include reading a sequence of data addresses at a first one of the target ports (e.g., target port 125) and write that data to a second one of the target ports (e.g., target port 123). The burst transfer logic 111 may initiate a read operation from target port 125 to the FIFO 117. However, during the read operation, the safety check module 115 may determine that the data is corrupted. For instance, the safety check module 115 may determine that the data being read in may show errors. Accordingly, the safety check module 115 may work with the burst logic 111 to cause the read operation to be terminated before the entire sequence of data addresses has been read.

In another example, burst transfer logic 111 may initiate a read operation from target port 125 to the FIFO 117. During the read operation, the security check module 114 may determine that at least some portion of the read operation is not allowed. The security check module 114 may work with the burst logic 111 to cause the read operation to be terminated before the entire sequence of data addresses has been read.

In another example, burst transfer logic 111 may initiate a read operation from target port 125 to the FIFO 117. Subsequently, and before the entire sequence of addresses has been read, channel control module 116 may determine that a trigger 108 has arrived from a higher-priority channel. The channel control module 116 may work with the burst logic 111 to terminate the lower-priority read operation in favor of the higher priority transfer. Once the higher priority transfer has been completed, the channel control module 116 may work with the burst logic 111 to restart the lower-priority read operation and finish out the lower-priority transfer.

Furthermore, the burst logic 111 may track an amount of space in the FIFO 117 and, if there is a threshold amount of space left in the FIFO 117, may allow a sequential read operation to continue beyond a first data chunk and into a second data chunk. In other words, burst logic 111 may be configured to opportunistically extend a sequential read when there is enough space in the FIFO 117 to accommodate further reading from a target port.

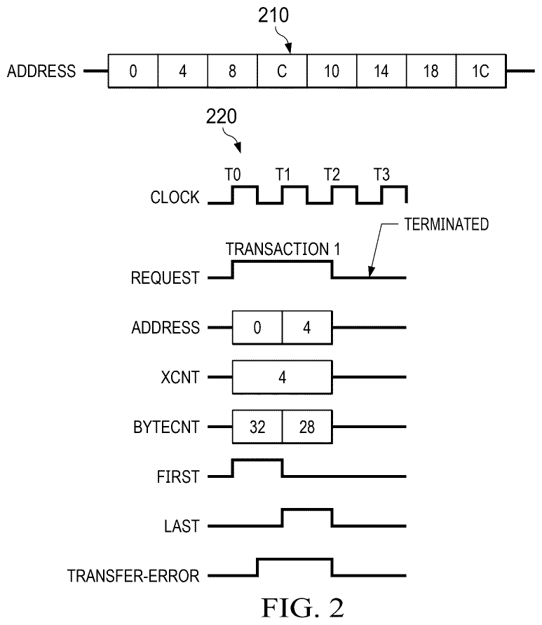

FIG. 2 is an illustration of an example adaptive burst transfer, which may be performed by DMA controller 110 during a burst transfer from a first one of the target ports 121-126 to another one of the target ports 121-126. Signal diagram 220 describes various signals associated with a read operation of the data transfer.

The example burst transfer, which may be defined by a trigger, includes reading addresses from 0-1F, as shown by the sequence of addresses 210, which may be specified by the processor core 106 via the configuration interface 113 of the DMA controller 110. Note that 1F is the last address to be read in the sequence of addresses 210, as 1C+3 is 1F. The data words read out from the addresses 0-1F may be referred to as a data chunk. In other words, in this example, the DMA controller 110 may receive a trigger 108 to transfer a data chunk, including reading the data chunk from a source target port. For instance, the trigger 108 may define a source starting address and a size, which the DMA controller 110 may translate into the sequence of addresses 210. Note in this example that the addresses are given in hexadecimal numbers, rather than decimal numbers.

In the example, the DMA controller 110 provides six signals to the target ports 121-126 (including a source target port thereof): REQUEST, ADDRESS, XCNT, BYTECNT, FIRST, and LAST. The rising edges of the clock used to communicate with the source target port are given as times T0-T3. The DMA controller 110 begins the read operation from the target port at time TO by bringing the REQUEST signal high. The REQUEST signal may indicate to the source target port that a read operation is enabled. The DMA controller 110 also brings the FIRST signal high, where the FIRST signal indicates a first beat of the data read operation and also causes the target port to give exclusive bus access to the DMA controller 110. The ADDRESS signal is a signal from the DMA controller 110 to the target port to indicate an address, and the DMA controller 110 increments the address by an increment in the XCNT signal. Specifically, the XCNT signal indicates a number of bytes transferred, so the data source target port may read beginning at address 0 and read out four addresses beginning at address 0. The length of the address fields, as given by the XCNT signal, to be read out stays the same throughout the entire transfer in this example. The DMA controller 110 also transmits a signal BYTECNT, which begins with a total number of bytes to be read out, and the DMA controller 110 decrements the BYTECNT signal at each beat.

At time T0, the source target port is controlled so that the read operation is enabled by the REQUEST signal, the starting address is set at address 0, and the target port is instructed to read from a sequential group of four addresses in the first beat. The first beat lasts from time T0 to time T1. During this time, the source target port is controlled to perform a sequential read by virtue of the REQUEST signal and the FIRST signal, so the source target port begins a lookahead read, where it may perform low-level overhead to read out from addresses subsequent to the current range of addresses 0-3 in the first beat. For instance, even during the first beat, the source target port may begin performing low-level overhead to read out from addresses at address 4 and beyond.

However, before time T1 occurs, a TRANSFER-ERROR is detected by the DMA controller 110. For instance, the TRANSFER-ERROR may be associated with a signal may be strobed (e.g., asserted then de-asserted or vice versa) by the safety check module 115 in response to determining that a read out piece of data is corrupted. In another example, the TRANSFER-ERROR may be associated with a signal raised by the security check module 114 in response to determining that the read operation is prohibited. For instance, the DMA controller 110 may be prohibited from reading from the address range given by the sequence of addresses 210. Thus, the TRANSFER-ERROR signal may represent data, based upon which the burst logic 111 may determine to terminate the read operation. In response to the TRANSFER-ERROR, the DMA controller 110 may strobe the LAST signal to indicate to the target port to end the lookahead addressing and to end the burst transfer operation. Further, for compatibility, the DMA controller 110 may cause the REQUEST signal to go low, which also disables the read operation. In some examples, the REQUEST signal and the LAST signal may be used in combination to distinguish those interrupted transactions which are expected to resume. In one such example, when the LAST signal is asserted a cycle before the REQUEST signal is de-asserted, the transaction is not expected to be resumed, while when the REQUEST signal is de-asserted without the LAST signal being asserted, the transaction is expected to be resumed.

In the present example, the TRANSFER-ERROR signal goes high between time T0 and time T1. This causes DMA controller 110 to strobe the LAST signal at time T1. The target port returns data for the addresses from 4 to 7 by time T2 and ends the lookahead addressing and the read operation by time T2. The DMA controller 110 also causes the REQUEST signal to go low at time T2. In this example, the rising edge of the LAST signal coincides with the last address transmitted on the ADDRESS signal.

In the example above, the FIRST signal is transmitted by the DMA controller 110 to the source target port (e.g., target port 125), which causes the source target port to provide exclusive bus access to the DMA controller 110. For instance, the target port 125 may lock its bus 135 for exclusive access by DMA controller 110 in response to the FIRST signal and release that bus access in response to the LAST signal. In the present example, the DMA controller 110 and the source target port use the bus arbitration signals, FIRST and LAST, to begin and terminate the read operation. Furthermore, the DMA controller 110 may be configured to strobe the LAST signal at an arbitrary time different from an end of the data chunk, thereby allowing the DMA controller 110 to terminate the read operation early or to extend the read operation past an end of the data chunk.

In the example above, the use of the FIRST signal and the LAST signal makes the BYTECNT signal irrelevant to terminating the read operation. By contrast, other systems may use the BYTECNT signal to terminate the read operation. The scenario illustrated in FIG. 2 may provide advantages over other solutions. For instance, had the DMA controller 110 finished out the full transaction over the full sequential range of addresses 210, it would have transferred corrupted data. Various systems may handle corrupted data in different ways, though it may result in delays in processing and a repeat of the data transfer to attempt to get valid data. By contrast, system 100 in the scenario of FIG. 2 terminates the transfer early to avoid wasting clock cycles, thereby potentially adding speed and efficiency to system 100.

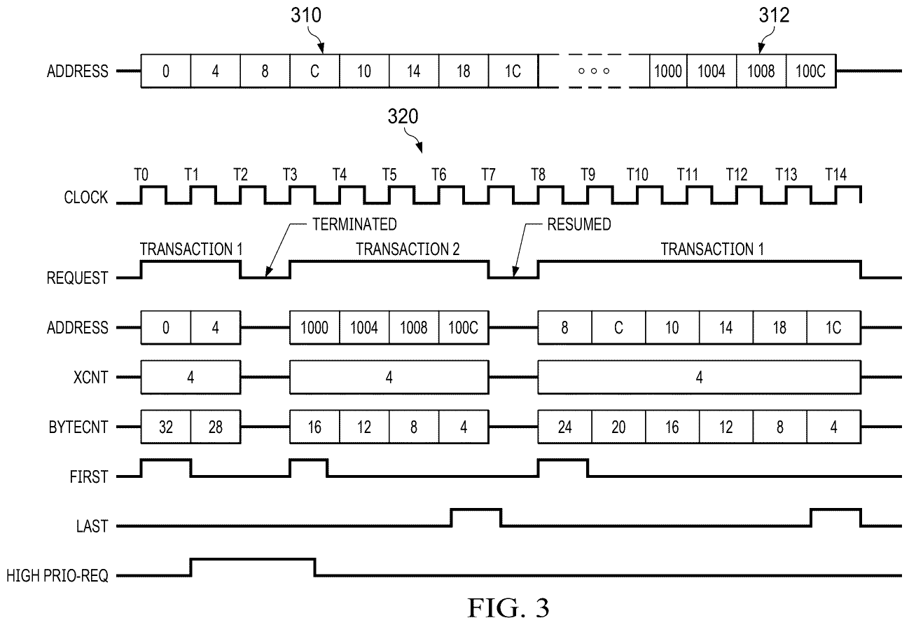

FIG. 3 is an illustration of example adaptive data transfers, which may be performed by DMA controller 110, according to various embodiments. Signal diagram 320 provides an illustration of example signals associated with the data transfers.

Once again, the rising edges of the clock are given as time T0 through time T14. A first sequential range of addresses, associated with a first data chunk and a first channel, is given by sequential addresses 310. Similarly, a second sequential range of addresses, associated with a second data chunk and a second data channel, is given by sequential addresses 312. In the present example, sequential addresses 312 are associated with a higher priority channel than are sequential addresses 310. As noted above, the priority of channels may be configured by the processor core 106, and channel control module 116 may track priorities of channels and their associated transfers. Further in this example, the data transfer (Transaction 1) associated with sequential range of addresses 310 may correspond to a first source target port (e.g., target port 125), and the data transfer (Transaction 2) associated with sequential range of addresses 312 may correspond to a second source target port (e.g., target port 121).

The first transfer, associated with sequential range of addresses 310, begins at time TO, where the DMA controller 110 makes the REQUEST signal goes high and strobes the FIRST signal. The DMA controller 110 also provides the ADDRESS signal and the XCNT signal. In response, the source target port begins the read operation, including lookahead read operations. During the transfer, and at approximately time T1, the channel controller module 116 strobes the higher-priority request signal (HIGH PRIO_REQ), provided to the DMA controller 110. In response, DMA controller 110 terminates the transfer associated with sequential addresses 310 by dropping the REQUEST signal to low at time T2. By time T2, only two beats corresponding to an address range 0 through 7 have been read out as part of Transaction 1.

The DMA controller 110 then switches to Transaction 2 at time T3. The DMA controller 110 in this example does not strobe the LAST signal for the target port 125, but the bus 135 of target port 125 is released by REQUEST going to 0. The DMA controller 110 performs a read operation from target port 121 between times T3 and T7. Specifically, the DMA controller 110 uses the FIRST signal to cause the target port 121 to lock the bus 131 to the DMA controller 110 during Transaction 2, and DMA controller 110 uses the LAST signal to cause the target port 121 to end the read operation and release the bus 131.

At time T7, Transaction 2 has been completed for the sequential range of addresses 312 at target port 121. However, Transaction 1 for the sequential range of addresses 310 at target port 125 remains terminated and unfinished. DMA controller 110 then strobes the FIRST signal to indicate to target port 125 to begin the read operation at address 8 and using increments of four. DMA controller 110 strobes the FIRST signal at the rising edge of the clock at time T8. In response, the target port 125 begins reading at address 8 and uses increments of four addresses at each beat until finishing after time T14. At time T13, the DMA controller 110 strobes the LAST signal to the target port 125 to cause the target port 125 to release the bus access to bus 135. After time T14, both Transaction 1 and Transaction 2 are complete, with Transaction 2 being interleaved within performance of Transaction 1.

The scenario of FIG. 3 may provide advantages in example system 100. For instance, DMA controller 110, including burst logic 111, is configured to facilitate the earlier completion of Transaction 2. In some systems, higher priority transactions may correspond to processes that require real-time, or at least faster, completion. The scenario of FIG. 3 illustrates that example system 100 may provide faster completion of higher priority transactions, thereby allowing system 100 to support real-time operations or more important operations during runtime.

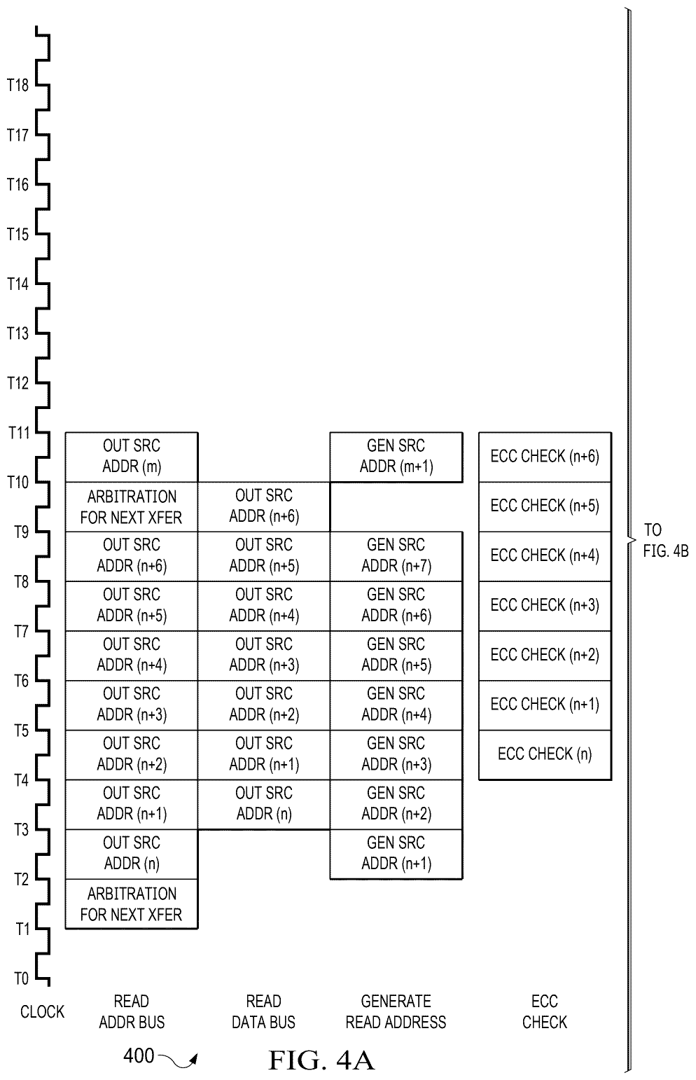

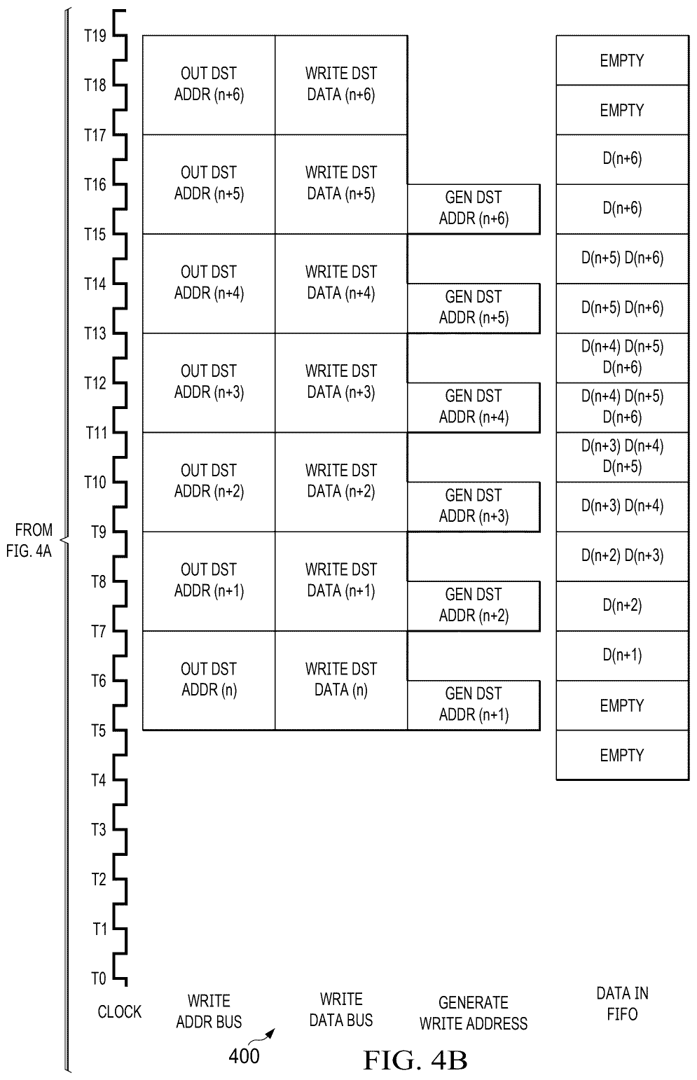

FIGS. 4A and 4B are an illustration of an example burst data transfer 400, which may be performed by system 100 of FIG. 1, according to various embodiments. For ease of illustration, burst data transfer 400 is not interrupted, though it is understood that the principles of the read operation actions, error correction code (ECC) actions, write operation actions, and FIFO operation actions apply to any burst transfer for system 100 of FIG. 1.

The rising edges of the system clock are labeled T0 through T19, and the system clock of FIGS. 4A and 4B corresponds to the clock 101 of FIG. 1. The Read Address Bus and the Read Data Bus may correspond to the data read interface 142, and the Write Address Bus and the Write Data Bus may correspond to the data write interface 141. The Data in FIFO may correspond to the FIFO buffer 117.

At time T1, the DMA controller 110 causes the source target port (e.g., target port 125) to lock its bus (e.g., bus 135) for a read operation. By time T2, the DMA controller 110 transfers an address signal (e.g., ADDRESS) for the first beat and increments the ADDRESS signal at each successive beat until time T9. At Time T9, the DMA controller 110 ends the read operation from the target port 125.

The reaction of the target port 125 is to begin reading out data on the Read Data Bus, which begins at Time T3. The target port 125 reads out data with each beat, ending at time T10. In one example, the DMA controller 110 strobes the FIRST signal at time T1 and strobes the LAST signal at time T9. The Generate Read Address row illustrates the lookahead read operation, where the target port 125 generates an address for the next beat.

As the data arrives on the data bus, the safety check module 115 performs an error correction code (ECC) check, which begins at time T4 and occurs at each beat until it ends at time T11. Further in this example, the FIFO 117 starts out as empty and only begins to fill at around time T5.

The data transfer has a read operation component with target port 125 and a write operation component with a target port, e.g., target port 123, in this example. In other words, the present example illustrates a data transfer from an ADC to main memory. The DMA controller 110 transmits data addresses on the Write Address Bus to the target port 123 and also transmits the data itself on the Write Data bus. The writing begins at time T5. The target port 123 (being written to) may generate lookahead write addresses in response to this burst data transfer by generating addresses for each subsequent beat also beginning at time T5.

As time progresses, the write operations take twice as long to complete as the read operations, so the FIFO 117 begins filling around time T5 to accommodate the data being read in, and it peaks in used capacity between times T10 and T13. The DMA controller 110 writes the read-in data into a first end of the FIFO and reads the data out of the other end of the FIFO 117 to write that data to the target port 123. As illustrated, during a burst transfer, the spare (unused) capacity of the FIFO 117 may decrease as data is read in but not read out as quickly, and as the read operation finishes, the spare capacity of the FIFO 117 may increase until the FIFO 117 is empty. In the example of FIGS. 4A and 4B, the FIFO 117 empties at around time T17. The burst transaction is completed at time T19 as the last beat of data is written to the target port 123.

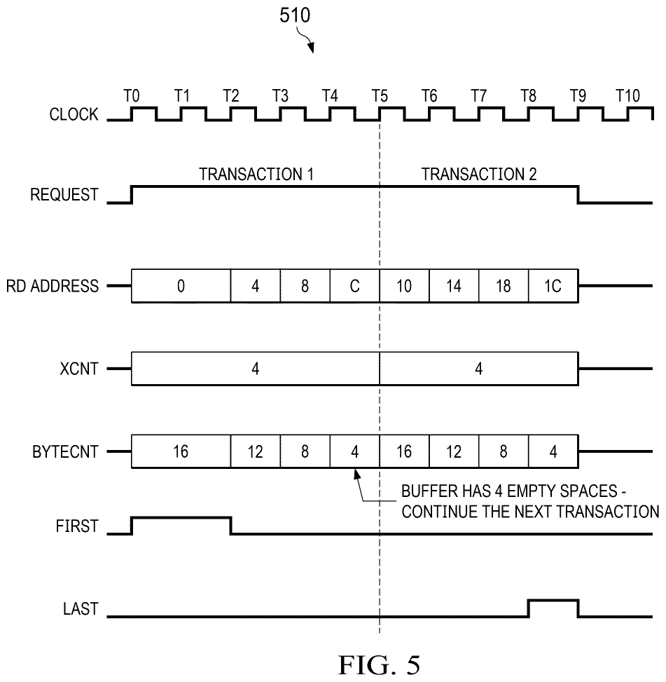

FIG. 5 is an illustration of operation of the DMA controller 110 to extend a read operation, according to various embodiments. FIG. 5 includes a signal diagram 510 to illustrate the signals from DMA controller 110 to a source target port (e.g., target port 125).

The DMA controller 110 begins Transaction 1 by asserting the REQUEST signal, which enables a read operation of the target port 125. The DMA controller 110 also strobes the FIRST signal, which indicates to the target port 125 that the first beat begins at time T0, and the FIRST signal causes the target port 125 to lock its bus 135 for exclusive access by the DMA controller 110 during Transaction 1. The DMA controller 110 indicates the first address in a sequence of addresses as address 0, and the DMA controller 110 indicates an increment at each beat (XCNT) of four addresses.

In response, the target port 125 begins reading the data, including performing lookahead operations, as long as the REQUEST signal remains high and as long as the LAST signal is not strobed. During Transaction 1, the DMA controller 110 receives a second trigger 108 to perform a second transaction (Transaction 2) on a sequential address range that is contiguous with the sequential address range of Transaction 1 (0 through 1F). Furthermore, this example assumes that Transaction 1 and Transaction 2 apply to a same channel and so that there is no discrepancy in priority.

As Transaction 1 continues, DMA controller 110 monitors the used and unused capacity of FIFO 117 so that at time T4, there remains unused capacity in the buffer for an additional beat of read-in data. The concept of used and unused capacity as discussed in more detail above with respect to FIGS. 4A and 4B. DMA controller 110, including burst logic 111, is configured to extend the read operation from the target port 125 in the event of spare capacity and a pending transaction. Therefore, DMA controller 110 determines to extend the read operation in response to analyzing the unused capacity of the FIFO 117. This may be performed even though BYTECNT has indicated the end of Transaction 1 because of the use of the LAST signal. Specifically, the DMA controller 110 delays strobing the LAST signal until the end of Transaction 2 at time T8. Otherwise, to end Transaction 1, the DMA controller 110 would have strobed the LAST signal at time T4.

FIG. 5 illustrates an advantage of some embodiments. Specifically, the example of FIG. 5 avoids overhead that would have been incurred by ending Transaction 1 and then re-starting the read operation for Transaction 2. In other words, the bus releasing and re-locking for the bus 135 of the target port 125 may take at least one clock cycle and perhaps more. However, in this example, the DMA controller 110, including burst logic 111, is configured to extend the read operation by not releasing and then re-locking the bus 135 between Transaction 1 and Transaction 2, thereby saving at least one clock cycle. As a result, the system 100 of FIG. 1 may reduce overhead and save clock cycles and, thus, enjoy an increase in speed of operation in some scenarios.

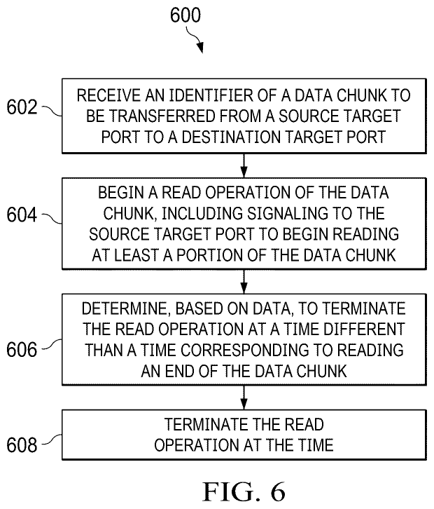

FIG. 6 is an illustration of example method 600, to provide adaptive burst transfer control, according to various embodiments. In one example, method 600 may be performed by DMA controller 110, including burst logic 111, to move data from one of the target ports 121-126 to another of the target ports 121-126.

At action 602, the DMA controller 110 receives an identifier of a data chunk to be transferred from a source target port to a destination target port. For instance, the DMA controller 110 may receive a trigger, such as a trigger 108 of FIG. 1. The trigger may indicate a source address, a size, and a destination address. The source address may correspond to a starting address within a range of addresses in the source target port, and the destination address may correspond to a starting address within a range of addresses in the destination target port.

In this example, the data chunk includes multiple data words in a sequential range of addresses. In other words, the data chunk is larger than a byte of data, and the transfer includes a sequential read operation in the range of addresses beginning at the starting address and includes a sequential write operation in the range of addresses beginning at the destination address.

An example sequential read operation is illustrated by the sequential range of addresses 210 of FIG. 2, sequential range of addresses 310 of FIG. 3, the range of addresses on the Read Address Bus of FIGS. 4A and 4B, and the range of addresses of Transaction 1 of FIG. 5. FIGS. 4A and 4B also illustrate an example sequential write operation using the Write Address Bus and the Write Data Bus.

At action 604, the DMA controller 110 begins a read operation of the data chunk. For instance, action 604 may include signaling to the source target port to begin reading at least a portion of the data chunk. In the examples of FIGS. 2, 3, and 5, the DMA controller 110 strobes the FIRST signal to indicate to the source target port to provide exclusive bus access to the DMA controller and that a first beat of a read operation has begun.

Action 604 may also include the DMA controller 110 using the REQUEST signal to cause the source target port to enable a read operation.

At action 606, the DMA controller 110 determines, based on data, to terminate the read operation at a time that is different than a time corresponding to reading an end of the data chunk. In one example, such as in the scenario of FIG. 2, the data includes error data that may be generated by security check module 114 (e.g., lack of access permission) or safety check module 115 (e.g., transfer error). In the example of FIG. 3, the data may include the higher-priority request. In the example of FIG. 5, the data may include data indicating used or unused capacity of a FIFO buffer.

At action 606, the time corresponding to reading an end of the data chunk may include a clock cycle that would otherwise correspond to reading out a last beat of the data chunk. In the example of FIG. 2, the time corresponding to reading the end of the data chunk would correspond to a clock cycle reading out data from the address 1CF. In the example of FIG. 2, the DMA controller 110 determines to terminate the read operation at time T2, which is an earlier clock cycle than would have been encountered at the end of the data chunk.

In the example of FIG. 3, the DMA controller 110 determines to terminate the read operation of Transaction 1 at time T2 and then to resume at time T8. In the example of FIG. 5, the end of the data chunk of Transaction 1 corresponds to time T5, and the DMA controller 110 determines to terminate the read operation at a later time T9 to accommodate further sequential reads of Transaction 2.

At action 608, the DMA controller 110 terminates the read operation at the time, which is different than a time corresponding to reading the end of the data chunk. For instance, the DMA controller 110 may strobe the LAST signal to indicate a last data beat to be read as well as to cause the source device to release the exclusive bus access. Further, the DMA controller 110 may cause the REQUEST signal to go low, thereby causing the source device to disable the read operation.

The scope of implementations is not limited to the actions 602-608 of FIG. 6. Rather, various implementations may add, omit, rearrange, or modify various ones of the actions. For instance, in the case of a transaction being terminated for a transfer error, the DMA controller 110 may retry the transaction. In the case of a transaction being terminated for lack of access permission, the DMA controller 110 may raise an error or take other appropriate action. In an instance in which the transaction is ultimately completed, the DMA controller may further write the transfer data to the destination target port.

Also, method 600 may or may not include a signal indicating a remainder of bytes remaining in the transaction (e.g., the BYTECNT signal). For instance, in some systems, the BYTECNT signal starts at a total number of bytes of the data chunk, and the DMA controller decrements the count with every beat. The DMA controller 110 may be configured to provide a BYTECNT signal, though in adaptive burst signaling, the BYTECNT signal may be irrelevant. In other words, while the BYTECNT signal may be used in some systems to define a beginning and an end of a burst transaction, various implementations described herein may instead use the FIRST and LAST signals and the REQUEST signal. In any event, the BYTECNT signal may or may not be used, depending on the application.

Furthermore, while the example of FIG. 6 is given with respect to a read operation, the scope of implementations may further include the DMA controller terminating a write operation at a time that is different than a time corresponding to writing the end of the data chunk. For instance, after action 604, the DMA controller may begin a write operation of the data at the destination target port. The determining, based on the data at action 606, may also include the DMA controller determining to terminate the write operation at the destination target port either before or after a time that corresponds to writing the end of the data chunk. For instance, the DMA controller may determine to terminate the write operation in response to a safety or security error, in response to a higher priority transaction, in response to used or unused capacity, or the like. Action 608 may also include terminating the write operation.

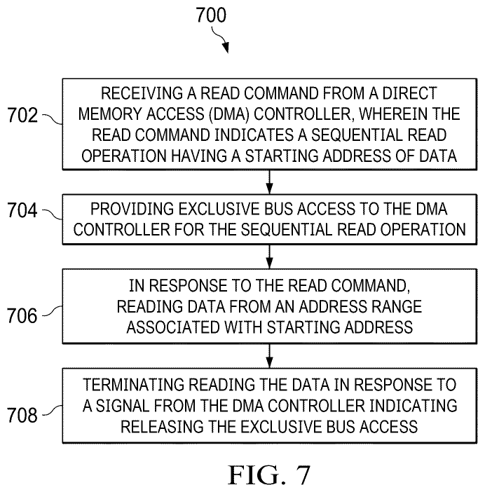

FIG. 7 is an illustration of example method 700, for accommodating adaptable burst transactions, according to various embodiments. In some examples, method 700 may be performed by a device associated with one of the target ports 121-126 of FIG. 1. For instance, each of the devices associated with target ports 121-126 be configured to interact with the DMA controller 110, as discussed above, and using signals that are the same as or similar to the REQUEST, FIRST, and LAST signals of FIGS. 2, 3, and 5. The functionality of the devices associated with the target ports may be hardware-based, firmware-based, or software-based, as appropriate.

In one example, a peripheral device, such as corresponding to target ports 121-122, may include any appropriate peripheral device. Examples of peripheral devices may include storage drives, video cards, audio cards, and the like. Such peripheral devices may each include a controller that is configured to interact with the DMA controller 110 and to read and/or write data as appropriate.

In the example of static random access memory (SRAM) target ports 123-124, such devices may include internal memory controllers. Such internal memory controllers may be configured to interact with the signals from the DMA controller 110 and then to read and/or write data to an array of memory bit cells as appropriate. In the example of ADCs, such as those corresponding to target ports 125-126, the results of the ADCs may be stored in a separate memory or internally to the ADCs. In any event, the results of the ADCs may be stored in registers or other volatile memory, which are controlled by a controller configured to interact with the DMA controller 110.

At action 702, the device receives a read command from the DMA controller. The read command indicates a sequential read operation having a starting address of data. In the examples above, a read command may include the REQUEST signal (enabling a read operation), the ADDRESS signal (providing a starting address), and the XCNT signal (an address interval, a size of data in a beat), and the FIRST signal (indicating a first beat of data and requesting exclusive bus access).

At action 704, the device provides exclusive bus access to the DMA controller for the sequential read operation. For instance, in the examples above, the device provides exclusive bus access to the DMA controller in response to the FIRST signal and maintains the exclusive bus access until the device detects the LAST signal or REQUEST equals 0. In other words, in the examples above, the exclusive bus access as well as the read operation itself have an indefinite time.

At action 706, the device reads data from an address range associated with the starting address of data in response to the read command. Specifically, in the examples above, the device may begin lookahead operations as well as may begin reading data beginning at the starting address.

At action 708, the device terminates reading the data in response to a signal from the DMA controller indicating releasing the exclusive bus access. For instance, in the examples above, the DMA controller 110, including the burst logic 111, uses the LAST signal to identify a final beat of data to be read out as well as to cause the device to release the exclusive bus access. In action 708, the device receives the LAST signal and responds to the LAST signal by terminating the read operation. The DMA controller and the device may also use the REQUEST signal to terminate the read operation.

In the example of FIG. 2, the device ends the read operation early in response to the LAST signal being strobed and in response to the REQUEST signal going low. In the example of FIG. 5, the device continues to read in a sequential range of addresses, and even beyond a range of addresses corresponding to Transaction 1, in response to the DMA controller 110 delaying the LAST signal. In the example of FIG. 3, the device performs Transaction 2 interleaved within Transaction 1 and ends the read operation of Transaction 1 in response to the LAST signal and in response to the REQUEST signal going low.

The scope of implementations may include adding, omitting modifying, or rearranging various actions. For instance, the device may respond to other commands, perhaps from the processing core or from the DMA controller, subsequent to the actions 702-708.

Corresponding numerals and symbols in the different figures generally refer to corresponding parts, unless otherwise indicated. The figures are not necessarily drawn to scale. In the drawings, like reference numerals refer to like elements throughout, and the various features are not necessarily drawn to scale. In the following discussion and in the claims, the terms “including,” “includes,” “having,” “has,” “with,” or variants thereof are intended to be inclusive in a manner similar to the term “comprising,” and thus should be interpreted to mean “including, but not limited to . . . ” Also, the terms “coupled,” “couple,” and/or or “couples” is/are intended to include indirect or direct electrical or mechanical connection or combinations thereof. For example, if a first device couples to or is electrically coupled with a second device that connection may be through a direct electrical connection, or through an indirect electrical connection via one or more intervening devices and/or connections. Elements that are electrically connected with intervening wires or other conductors are considered to be coupled. Terms such as “top,” “bottom,” “front,” “back,” “over,” “above,” “under,” “below,” and such, may be used in this disclosure. These terms should not be construed as limiting the position or orientation of a structure or element but should be used to provide spatial relationship between structures or elements.

The term “semiconductor die” is used herein. A semiconductor device can be a discrete semiconductor device such as a bipolar transistor, a few discrete devices such as a pair of power FET switches fabricated together on a single semiconductor die, or a semiconductor die can be an integrated circuit with multiple semiconductor devices such as the multiple capacitors in an A/D converter. The semiconductor device can include passive devices such as resistors, inductors, filters, sensors, or active devices such as transistors. The semiconductor device can be an integrated circuit with hundreds or thousands of transistors coupled to form a functional circuit, for example a microprocessor or memory device. The semiconductor device may also be referred to herein as a semiconductor device or an integrated circuit (IC) die.

The term “semiconductor package” is used herein. A semiconductor package has at least one semiconductor die electrically coupled to terminals and has a package body that protects and covers the semiconductor die. In some arrangements, multiple semiconductor dies can be packaged together. For example, a power metal oxide semiconductor (MOS) field effect transistor (FET) semiconductor device and a second semiconductor device (such as a gate driver die, or a controller die) can be packaged together to from a single packaged electronic device. Additional components such as passive components, such as capacitors, resistors, and inductors or coils, can be included in the packaged electronic device. The semiconductor die is mounted with a package substrate that provides conductive leads. A portion of the conductive leads form the terminals for the packaged device. In wire bonded integrated circuit packages, bond wires couple conductive leads of a package substrate to bond pads on the semiconductor die. The semiconductor die can be mounted to the package substrate with a device side surface facing away from the substrate and a backside surface facing and mounted to a die pad of the package substrate. The semiconductor package can have a package body formed by a thermoset epoxy resin mold compound in a molding process, or by the use of epoxy, plastics, or resins that are liquid at room temperature and are subsequently cured. The package body may provide a hermetic package for the packaged device. The package body may be formed in a mold using an encapsulation process, however, a portion of the leads of the package substrate are not covered during encapsulation, these exposed lead portions form the terminals for the semiconductor package. The semiconductor package may also be referred to as a “integrated circuit package,” a “microelectronic device package,” or a “semiconductor device package.”

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A direct memory access (DMA) controller configured to:
receive an identifier of data to be transferred from a source device to a destination device;
begin a read operation of the data by providing a set of signals that specifies to the source device an expected size of the data and that specifies to begin reading at least a portion of the data;
determine to terminate the read operation before the expected size of the data has been met; and
terminate the read operation.

2. The DMA controller of claim 1, wherein the controller is configured to receive the identifier of the data by receiving a source address and a size of the data.

3. The DMA controller of claim 1, wherein the controller is configured to receive the identifier of the data as a trigger from the source device.

4. The DMA controller of claim 1, wherein the source device comprises an analog-to-digital converter (ADC), and wherein the destination device comprises a memory device.

5. The DMA controller of claim 1, wherein the source device comprises a peripheral device, and wherein the destination device comprises a memory device.

6. The DMA controller of claim 1, wherein the DMA controller is configured to determine to terminate the read operation based on an indication of a transfer error, further wherein the DMA controller is configured to terminate the read operation.

7. The DMA controller of claim 1, wherein the DMA controller is configured to determine to terminate the read operation based on an indication of a lack of access permission, further wherein the DMA controller is configured to terminate the read operation.

8. The DMA controller of claim 1, wherein the DMA controller is configured to determine to terminate the read operation based on an indication of a higher-priority transaction, further wherein the DMA controller is configured to terminate the read operation and resume the read operation of the data after completion of the higher-priority transaction.

9. The DMA controller of claim 1, wherein the DMA controller is configured to determine to terminate the read operation based on an indication of unused capacity in a first in first out (FIFO) buffer for a further transaction, further wherein the DMA controller is configured to terminate the read operation.

10. The DMA controller of claim 1, wherein the DMA controller is configured to begin the read operation by causing the source device to provide bus access to the DMA controller for the read operation, further wherein the DMA controller is configured to terminate the read operation by transmitting a signal to the source device that causes the source device to stop the read operation and release the bus access.

11. The DMA controller of claim 1, wherein the DMA controller is further configured to:
move the data from the read operation into a first in first out (FIFO) buffer; and
write the data from the FIFO buffer to the destination device.

12. A method comprising:
receiving a read command from a direct memory access (DMA) controller, wherein the read command indicates a sequential read operation having an address of data and indicates an expected size of a set of data associated with the read command;
providing exclusive bus access to the DMA controller for the sequential read operation;
in response to the read command, reading data from an address range associated with the address of data; and
terminating reading the data prior to reading an entirety of the set of data in response to a signal from the DMA controller indicating releasing the exclusive bus access.

13. The method of claim 12, wherein the read command includes a first signal indicating the sequential read operation, a second signal indicating the address, and a third signal indicating a size in bytes to be read from the address per clock cycle.

14. The method of claim 12, further comprising:
releasing the exclusive bus access in response to the signal.

15. The method of claim 12, wherein terminating reading the data comprises stopping sequential lookahead reading.

16. The method of claim 12, wherein the method is performed by a device storing the data in internal memory, and wherein reading the data includes reading the data from the internal memory.

17. A system comprising:
a processor core;
a direct memory access (DMA) controller configured to communicate with the processor core; and
a plurality of devices configured to communicate with the DMA controller;
wherein the DMA controller is configured to:
receive a trigger indicating a burst data transfer of a set of data from a first device of the plurality of devices to a second device of the plurality of devices;
read a subset of the set of data for the burst data transfer from the first device, including transmitting a first signal to the first device to cause the first device to provide exclusive bus access to the DMA controller; and
transmit a second signal to the first device to cause the first device to release the exclusive bus access at a time that is prior to reading of an end of the set of data.

18. The system of claim 17, wherein the DMA controller is configured to transmit the second signal to the first device in response to determining a data error.

19. The system of claim 17, wherein the DMA controller is configured to transmit the second signal to the first device in response to determining a lack of access permission for reading the data.

20. The system of claim 17, wherein the first device comprises a peripheral device, and wherein the second device comprises a memory device, wherein the processor core is configured to use the memory device as system memory.
